(19) United States
(12) Patent Application Publication
(10) Pub. No.: US 2019/0072920 A1
(43) Pub. Date: Mar. 7, 2019

(54) Optimization/Modeling-Free Economic Load Dispatcher for Energy Generating Units

(71) Applicants: Ali Ridha Ali, Halifax (CA); Mohamed E. El-Hawary, Halifax (CA)

(72) Inventors: Ali Ridha Ali, Halifax (CA); Mohamed E. El-Hawary, Halifax (CA)

(73) Assignee: Ali Ridha Ali, Halifax (CA)

(21) Appl. No.: 15/696,437

(22) Filed: Sep. 6, 2017

(51) Int. Cl. G05B 19/042; H02J 3/38

(52) U.S. Cl. CPC G05B 19/042; H02J 2003/007; H02J 3/381

(57) ABSTRACT

In the recent few decades, many traditional and modern optimization algorithms have been introduced to solve economic load dispatch (ELD) problems. These techniques require precise and accurate representation of realistic generating units. In addition to their complicated structures, there is a big gap between the realistic operation of generating units and their reflected mathematical models, where many technical challenges are neglected to simplify the corresponding ELD optimization problem. Based on a fact that most power systems maintain their operation records, an estimated economic load dispatch can be determined using these information recorded in operation logbooks and archiving servers. This invention is an optimization/modeling free (OMF) technique and it can be applied without using any special or expensive software. Moreover, it does not require to determine any parameter nor constraint, and all solutions are practical and feasible. It is tested with a real power system's data and it shows great results.

### TECHNICAL FIELD

Embodiments are generally related to electric power systems operation, and more specifically, in economic load dispatch (ELD) subject.

### BACKGROUND OF THE INVENTION

Optimal economic operation of electric power systems can be considered as a high-priority task that should be fulfilled in energy management systems (EMSs) to reduce the total operating costs, consumed fuel and emission rates.

Two main strategies are involved to achieve economic operation: the first one is to schedule the power output of the committed generating units to meet the desired load demand at the lowest possible power production cost. The second one is to minimize the network losses by controlling the real and reactive power flows. The first strategy is called the economic load dispatch (ELD) problem, while the second strategy is called the minimum-loss problem; and both strategies can be optimized by means of the optimal power-flow (OPF) technique.

To solve ELD problems, currently, there are two main streams called the analytical and numerical methods. The first one is mainly used in books to illustrate the concept of ELD problems. This approach can be applied if the given system is very small and has many simplifications (such as: neglecting network losses, emission rates, minimum and maximum limits of generating units). The second one is more suitable, and it can be applied to solve more complicated systems. Actually, numerical stream can be divided into four sub-streams. The first three sub-streams are called classical, modern, and hybrid optimization algorithms, The forth sub-stream is called artificial-intelligence-based (AI-based) algorithms.

In the literature, it is well known that ELD problems are highly constrained, non-linear, and non-convex. Thus, classical (also called traditional and conventional) optimization algorithms mostly fail to find the global, or at least near global, optimal solution without violating any constraint or trapping into local optimum solutions. Modern optimization algorithms (which come with different names, such as: nature-inspired, evolutionary, meta-heuristic, stochastic, population-based, hybrid algorithms) can solve many practical challenges, such as: initial guess, derivatives, and trapping into local optimum solutions. However, they are very slow algorithms, because they have probabilistic-based convergence rates while the classical optimization algorithms have gradient-based convergence rates. Therefore, many hybrid optimization algorithms, which are listed in the third sub-stream, have been designed to overcome the problems of both the classical and modern optimization algorithms. To give some sorts of smartness and robustness, the fourth stream has been established based on artificial intelligence (AI) algorithms, such as: fuzzy- and artificial neural networks-based approaches.

The main problem among all the preceding approaches is that they are modeling- and optimization-based approaches. This point can be mathematically described as follows:

Suppose there are n generating units, then the total operating cost Σᵢ₌₁ⁿCᵢ can be considered the objective function that needs to be optimized by these ELD solvers. This can be mathematically expressed as follows:

$$OBJ = min {\sum }_{i = 1}^{n} {C}_{i} ( {P}_{i} )$$

where Pᵢ is the real power (i.e., the independent variable) of the ith generating unit, and Cᵢ is the cost function (i.e., the dependent variable) of the ith generating unit.

This objective function is subjected to many constraints, such as:

Generator Active Power Capacity Constraint:

Pᵢ^{min}≤Pᵢ≤Pᵢ^{max}

where Pᵢ^{min} and Pᵢ^{max} are respectively the minimum and maximum allowable real powers supplied by the ith generating unit.

System Active Power Balance Constraint:

P_{T}−P_{D}−P_{L}=0

where P_{T} is the total real power generated by those n units (i.e., P_{T}=Σᵢ₌₁ⁿPᵢ), P_{D} is the real load demand, and P_{L} is the real power losses in the network.

Also, based on the type and operational philosophy of the given power station, there are many other constraints, such as: Spinning Reserve, Line Flow, Hydro-Water Discharge Limits, Reservoir Storage Limits, Water Balance Equation, Network Security, etc.

Is it easy to be done mathematically?! Thus, if someone wants to apply these classical approaches to solve real ELD problems, he will realize that there are many practical challenges need to be satisfied before being able to formulate that problem in a mathematical way. Some practical challenges during modelling such ELD optimization problems:

First, there are many uncertainties in the model itself! Is it built based on some assumptions or not? Does it have a precise objective function that can match the real behaviors of generating units with their mathematical models? Do the listed constraints cover all the aspects? Are there any hidden or unconsidered equality/inequality constraints? What about the other uncertainties due to fuzziness, vagueness, ambiguity, and subjective judgements of the designers? etc. based on these considerations, there is a highlighted doubt about the optimality and feasibility of the current solutions obtained by all the known ELD solvers presented in the literature. For example, Some approximated objective functions that are frequently used in ELD solvers:
OBJ as a normal cubic function (i.e., 3rd order polynomial equation):

Cᵢ(Pᵢ)=aᵢ+bᵢPᵢ+cᵢPᵢ²+dᵢPᵢ³
where aᵢ, bᵢ, cᵢ, and dᵢ are the regression coefficients of the ith generating unit.
Because the last coefficient (i.e., dᵢ) is very small, so it is usually dropped from the preceding equation to have a quadratic function (i.e., 2nd order polynomial equation):

Cᵢ(Pᵢ)=aᵢ+bᵢPᵢ+cᵢPᵢ²
With considering the valve-point loading effects, the preceding OBJ becomes:

Cᵢ(Pᵢ)=aᵢ+bᵢPᵢ+cᵢPᵢ²+|eᵢ×sin(fᵢ×(Pᵢ^{min}−Pᵢ))|
where eᵢ and fᵢ are the regression coefficients of the valve-point loading effects of the ith generating unit.
If the total emission-rate E produced from all the preceding n generating units is also considered, then this term can be mathematically represented as follows:

$$E ( {\sum }_{i = 1}^{n} {P}_{i} ) = {\sum }_{i = 1}^{n} [ {α}_{i} + {β}_{i} {P}_{i} + {γ}_{i} {P}_{i}^{2} + {ξ}_{i} exp ( {δ}_{i} {P}_{i} ) ]$$

where αᵢ, βᵢ, γᵢ, ξᵢ, and δᵢ are the regression coefficients of the ith unit's emission characteristics.

Second, operators need original equipment manufacturers (OEMs) or knowledgeable consultants in order to precisely determine a, b, c, d, e, f, α, β, γ, ξ, and δ coefficients. Usually, it is a costly contract!

Third, OEMs' manuals and technical documents are partially or completely lost! or even become useless if the units are retrofitted or rehabilitated (Ex: upgrading turbine, generator, transformer, etc, parts).

Fourth, speed and memory usage of the preceding algorithms can also create another set of challenges, because each EMS has a non-upgradable hardware that should be shared by many other packages (such as: power flow analysis, fault analysis, stability analysis, contingency analysis, and optimal coordination of protective relays). Thus, system engineers are forced to suppress some features of modern optimization algorithms (such as: population size, maximum iterations limit, and hybridization mode) in order to be able to design adaptive ELD solvers.

Five, the EMS software itself may become hard to be used; especially for those inexperienced operators. Many times, only original equipment manufacturers (OEMs) or third party providers can accomplish these technical tasks within the installed EMS software under an expensive periodic contract. The other approach is by offering a high paying jobs to employ some specialists.

Sixth, sometimes the EMS software itself is not fully licensed where each package (such as: power flow analysis, fault analysis, and economic load dispatch) needs an additional installation cost.

Seventh, ELD package could not be founded in some basic and outdated EMS software, such those installed in many very old electric systems in developing countries where only supervisory control and data acquisition (SCADA) system or distributed control system (DCS) is used.

Eighth, by supposing the xth power plant has k generating units and these machines are connected to a one common busbar, as shown in 30 of FIG. 3, then there is one hidden equality constraint for each power plant that should be satisfied in the existing ELD solvers:

P_{i,1}+P_{i,2}+ . . . +P_{i,k}=Pₓ

where Pₓ is the total real power generated by that xth power plant.

Thus, all these restrictions make using ELD strategy very hard, and we have seen many power stations operated without considering this strategy at all.

All these stiff technical problems can be bypassed by using our invention, which is the first technique that can solve ELD problems without using any mathematical model or any optimization algorithm. This is why we call it an optimization/modeling-free estimated economic load dispatcher (OMF-EELD). It is completely different than all the known analytical and numerical approaches presented in the literature.

The concept behind this OMF technique is as follows: in most, or maybe all, power stations there is one common routine job that should be carried out by the operators and monitored by the plant manager, head, or, at least, the operation senior shift-charge engineer. This routine job is simply “recording the real input and output readings of the corresponding power station(s)”. Some of these input readings are: turbine inlet temperature (TIT), temperature after turbine (TAT), turbine compressor discharge pressure, fuel consumption rate, air flow-rate, combustion chamber efficiency, ambient temperature and humidity, etc. Also, generated power, emission rates, auxiliary power consumption, etc, can be considered as output readings. This routine job could be done daily, per operation manpower shift, or hourly as described in 10 of FIG. 1. If the existing automation system (i.e., SCADA or DCS) has a built-in feature to save the measured values in the archiving server of EMS, then it could be possible to automatically save all these values within one minute or even one second updatable window as shown in the last columns of 10 of FIG. 1. This means a very huge real data can be easily extracted from this actual process.

### BRIEF DESCRIPTION OF THE DRAWINGS

FIG. 1 shows the total number of power station configurations for each type of data recording process.

FIG. 2 shows an illustrated flowchart of general electric power systems.

FIG. 3 shows the total power generated in the xth power plant if its k machines are connected to a one common busbar.

FIG. 4 depicts the mechanism of the local OMF algorithm through a flowchart.

FIG. 5 depicts the mechanism of the global OMF algorithm through a flowchart.

FIG. 6 depicts the mechanism of the local OMF algorithm through a pseudocode.

FIG. 7 depicts the mechanism of the global OMF algorithm through a pseudocode.

FIG. 8 illustrates a simplified arrangement of global-local ELD solvers for real electric power system applications.

FIG. 9 shows the specifications of the power station used in our experiment.

FIG. 10 shows a plot of the daily total power generation extracted from the real operation logbook of the power station used in our experiment.

FIG. 11 shows a plot of the daily auxiliary power consumption extracted from the real operation logbook of the power station used in our experiment.

FIG. 12 shows a plot of the daily fuel cost in US Dollar extracted from the real operation logbook of the power station used in our experiment.

FIG. 13 shows the single-line diagram of the power station used in the experiment.

FIG. 14 shows the fitness curve of the first scenario (i.e., when the auxiliary real power consumption is not considered) of the experiment.

FIG. 15 shows the fitness curve of the second scenario (i.e., when the auxiliary real power consumption is considered) of the experiment.

FIG. 16 shows the results of the first and second scenarios of the experiment. If the auxiliary real power consumption is considered then the net generation is used, and vice versa for the total generation.

FIG. 17 shows the station configuration (i.e., the ELD solution) obtained by our invention for the first scenario.

FIG. 18 shows the station configuration (i.e., the ELD solution) obtained by our invention for the second scenario.

FIG. 19 shows some pre-defined points used in our example of the classical linear and Lagrangian polynomial interpolations.

FIG. 20 gives a simplified diagram of the main loads connected to power stations of aluminum smelters.

FIG. 21 is an example of how the realistic operation logbooks look like. These data can be collected as shown in FIG. 1.

FIG. 22 is a snap-shoot of the performance test data taken from one gas turbine (GT) used in the experiment. This data is provided by ABB's (Asea Brown Boveri Inc) distributed control system (DCS) model ProControl P14. These data can be collected as shown in FIG. 1.

### DETAILED DESCRIPTION

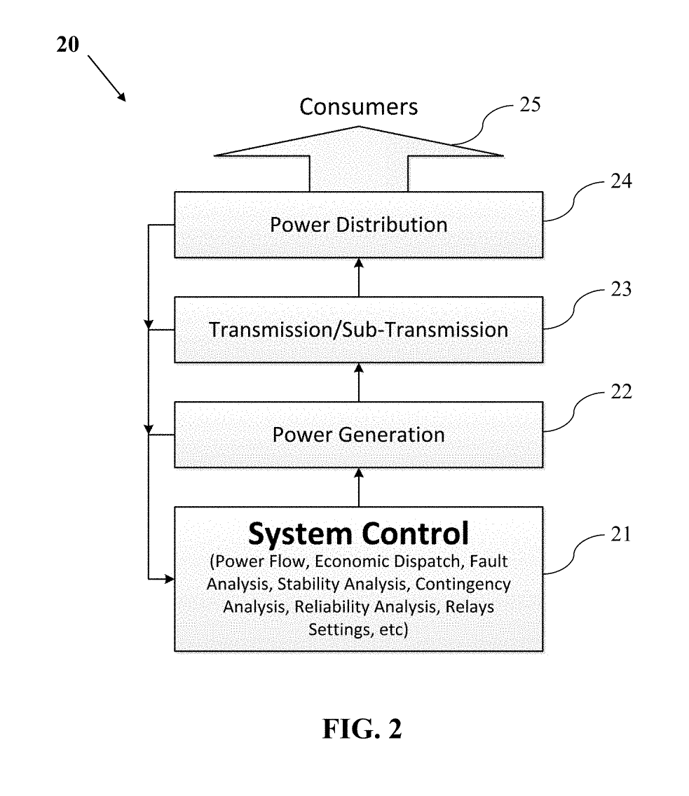

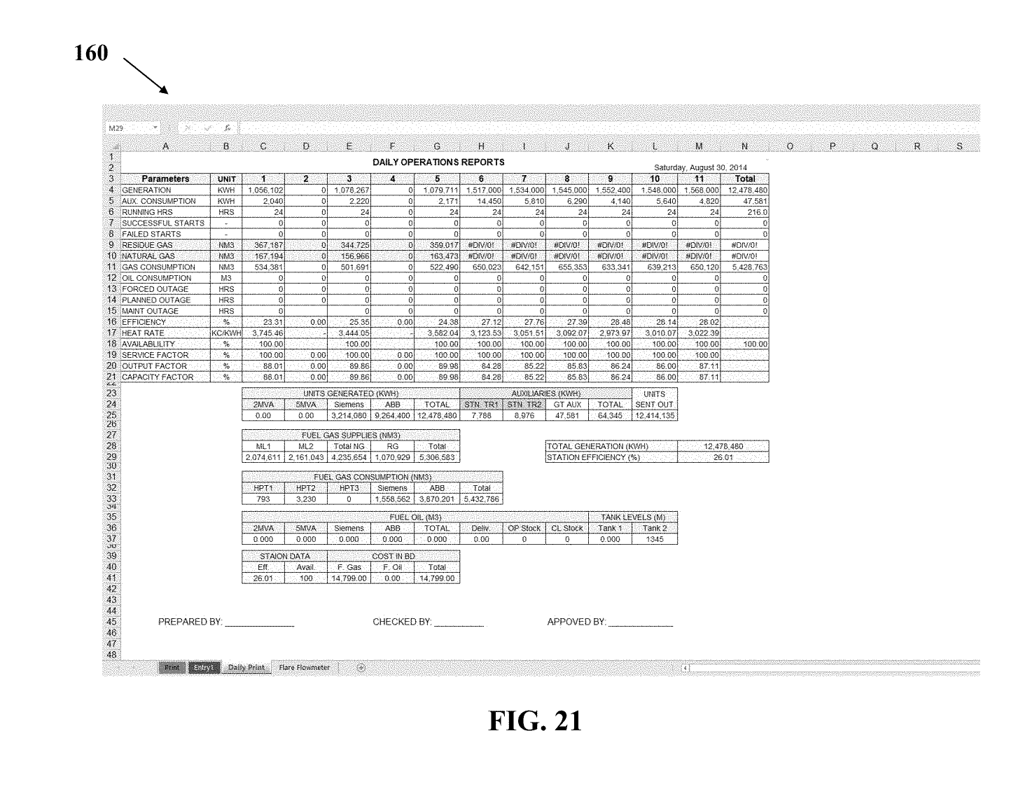

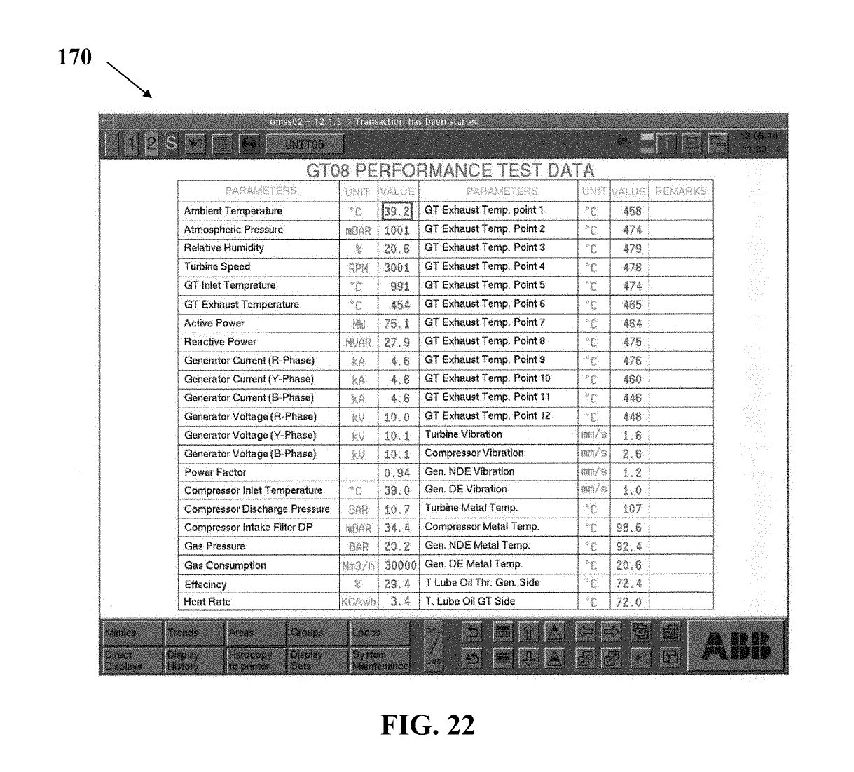

It has been seen that there are many practical challenges are faced during designing existing classical ELD problem solvers. Practically, achieving all these revealed and hidden challenges (which are translated as additional terms of objective functions and/or constraints) is not an easy task; especially if there is no enough technical support from OEM or knowledgeable consultants, and if the commissioning manuals and other documents are completely or partially lost. Add to that, most power stations' administrative staffs reject doing online training on their EMS software without a direct supervision from OEMs, particularly during winter season (in cold countries) or summer season (in hot countries) where the energy consumption rates are at the highest levels. Instead, our invention can be used to estimate the optimal solution based on the available real data recorded in the operation logbook as shown in 160 of FIG. 21, and/or archiving server(s) as shown in 170 of FIG. 22. To know how our OMF technique works, consider FIG. 2, which shows the master control flow of any electric power system.

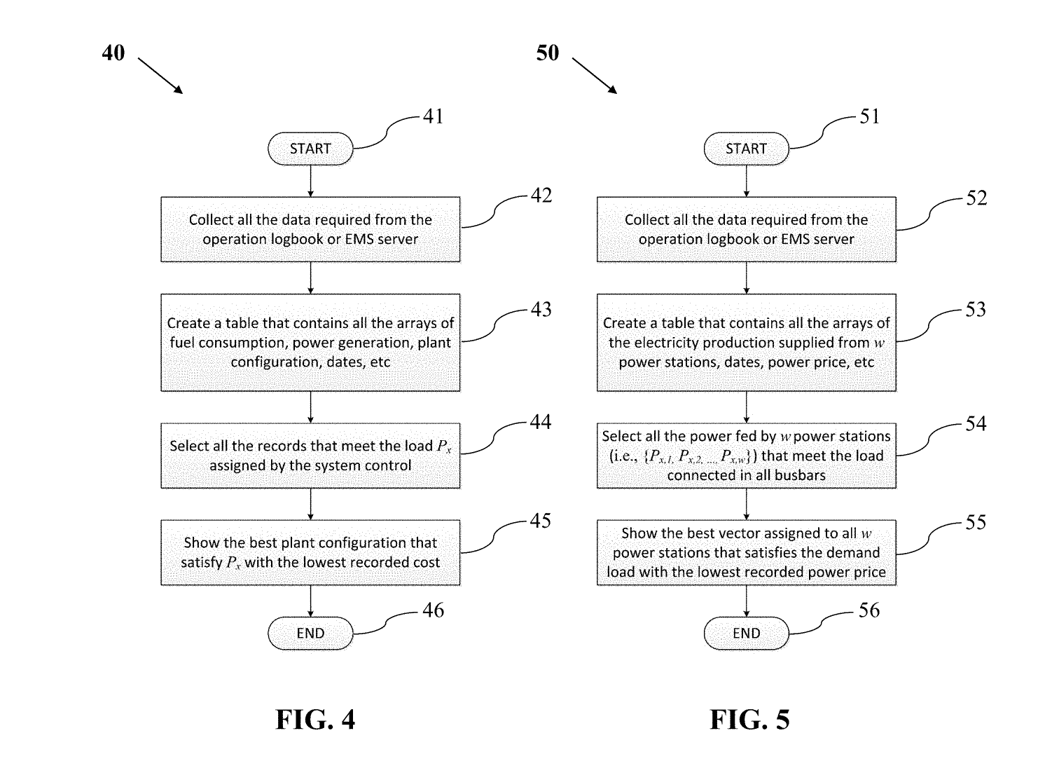

The power system control (or automation center) 21 is responsible to instruct each power station 22 to supply a specific amount of power (Pₓ) to the grid 24 through transmission and sub-transmission lines 23, so that the network losses can be minimized and the system constraints can be satisfied. With multiple non-governmental power stations, the system control will not care whether the xth power station (PSₓ) generates its power Pₓ with an optimal cost or not, because the first one buys that power based on a contract. Thus, in this case, each power station is responsible to solve its own ELD problem. Thus, there are two stages to estimate the solutions of ELD problems, one is focused on each power station (i.e., optimizing 22 of FIG. 2) and the other is focused on the network losses (i.e., 23 and 24 of FIG. 2). These two stages are respectively called local and global OMF-EELD, and they are described in FIG. 4 to FIG. 7 through flowcharts and pseudocodes. More details about these four figures will be given later.

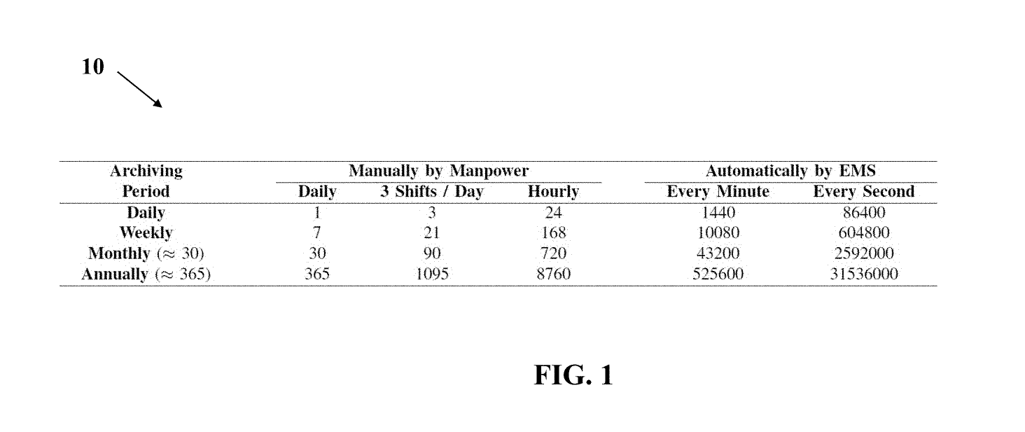

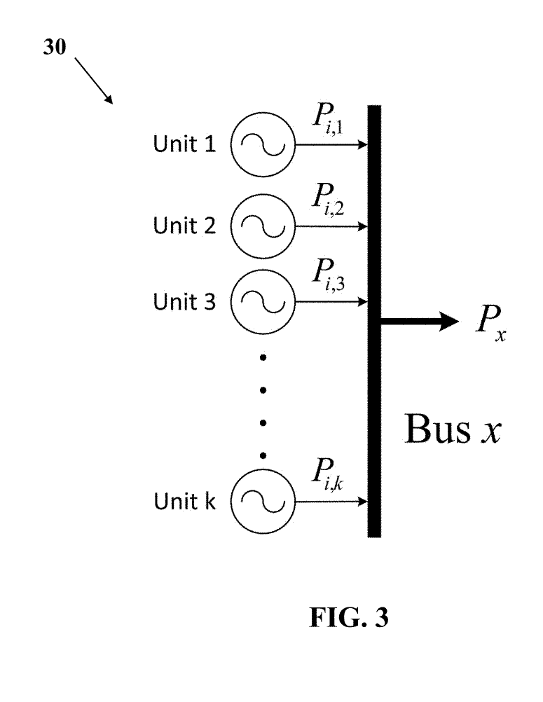

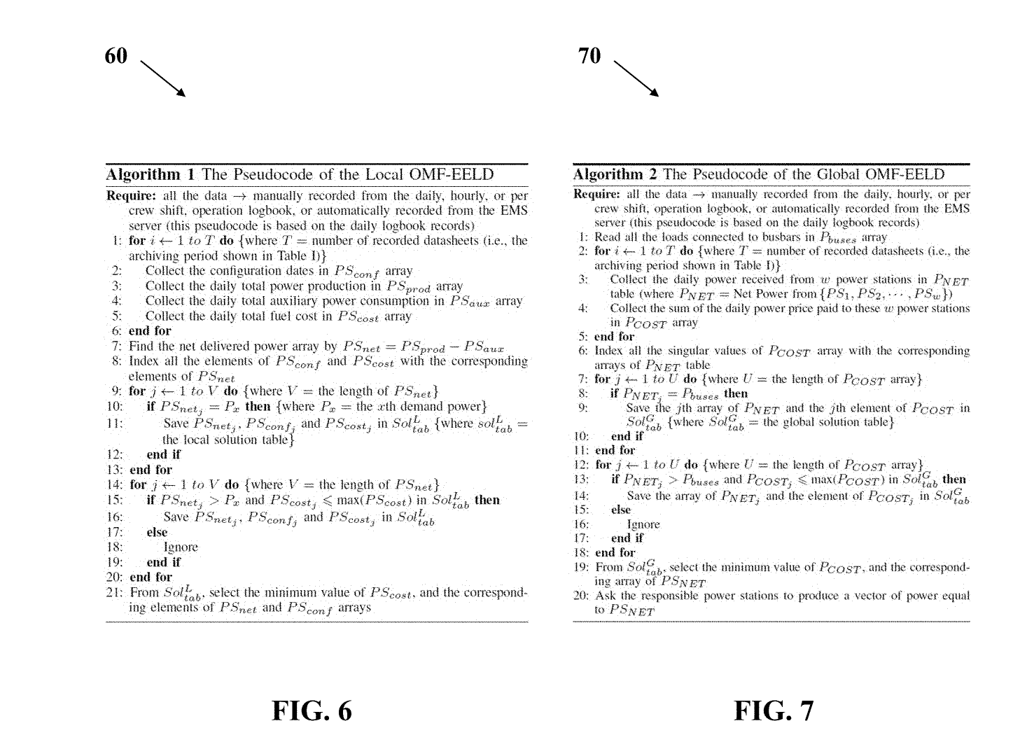

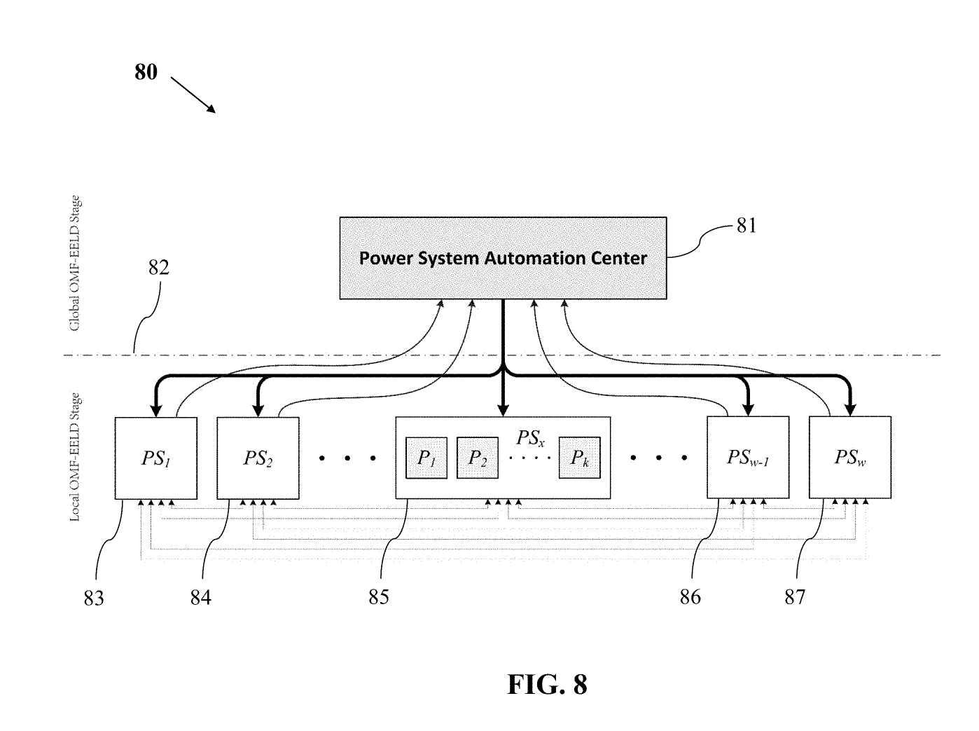

The local OMF-EELD is responsible to estimate the optimal economic operation of each individual power station. Thus, if there are w power stations, then there will be w local OMF-EELD as illustrated in 80 of FIG. 8. To explain the mechanism of OMF-EELD and how it works, suppose the xth power station contains k generating units as illustrated in 30 of FIG. 3. In the real world applications, the power generated from many power stations are supplied to the corresponding network through some common busbars, such as the xth busbar shown in FIG. 3. This realistic arrangement create w equality constraints for classical ELD solvers, as described in the latest equation (i.e., the equation of the paragraph [021]), which is really hard to be satisfied. Here, the local OMF-EELD can avoid this stiff modeling by effectively utilizing the real database stored in operation departments to extract the estimated optimal solutions of these power stations. If the corresponding power station is very old, then it is supposed that the archiving servers of EMS, SCADA, and DCS are either not available or not activated. In this case, the operators will mainly depend on their manually entered data in the operation logbooks as shown in 160 of FIG. 21. The data length will depend on the recording mode used in each power station as explained in 10 of FIG. 1. Fortunately, most of power stations contain, at least, one automation and energy management systems; even those that are remotely monitored and controlled from far sites have PLCs (programmable logic controllers) with field operator control panels, which act as RTUs (remote terminal units). Therefore, the data can be automatically and precisely gathered as shown in 170 of FIG. 22, and the data length is much bigger than that manually obtained by logbooks as explained in 10 of FIG. 1. Such these input/output data (I/Os) are: configuration date, gas consumption, units' power output, auxiliary power consumption, emission rates, and ambient temperature and humidity. These real and practical records contain huge amount of useful information. They can be used to find the best achieved configuration that meets the end-users' power consumption with the lowest recorded production cost. The mechanism of this local OW-EELD technique can be described through the flowchart shown in 40 of FIG. 4 and the pseudocode shown in 60 of FIG. 6. Please note that the preceding pseudocode is constructed for the simplified local OMF-EELD where the effects of temperature, humidity, emission rates, and other less weighted variables (please, refer to FIG. 21 and FIG. 22) are neglected. Any one of these variables can be easily inserted in the algorithm.

If all the w power stations (i.e., those shown through 83 to 87 of FIG. 8) are owned by a single player (i.e., a monopoly market), or if the system control shown in 21 of FIG. 2 cares about both the network losses and the production cost of each xth power station, then there is a global OMF-ELD that should be activated before carrying-out the local OMF-ELDs for all the w power stations. This process can be clarified through the block-diagram shown in 80 of FIG. 8. First, the global OMF-EELD is activated to make a comparison between the power required for the customers (i.e., the power demand or system load) and the powers fed from all the w power stations. The objective is to know the amount of power should be supplied from each xth power station with the lowest recorded losses in the network. Then, the local OMF-EELDs are individually activated in all the w power stations to estimate the best possible configurations. That is, by referring to FIG. 3 and FIG. 8, the global OMF-EELD configures the total power Pₓ supplied from each xth power station, while the local OMF-EELDs configure all the k individual units of each xth power station to generate that Pₓ with the lowest possible price. The mechanism of this global OMF-EELD technique can be described through the flowchart shown in 50 of FIG. 5 and the pseudocode shown in 70 of FIG. 7.

Instead of using one global OMF-EELD with w local OMF-EELDs, a single OW-EELD solver can be designed to optimize both the w power stations and the network's losses, but this approach has many weaknesses, such as:
The system control requires a full access to the data stored in all the w power stations, which is impossible if they are from different owners.
Even if these w power stations are owned by the same company (or the government), the tables dimensions (mentioned in FIG. 6 and FIG. 7) must agree to avoid many programming challenges.
The overall program structure becomes very insufficient and hard to be understood and/or traced by other programmers in case they want to upgrade/modify it.
The two stages approach shown in FIG. 8 is more flexible in case other variables (such as: emission rates, network security, and temperature) are considered, because the responsibility is shifted from the system control to the corresponding power stations (i.e., the local OMF-EELD solvers) to deal with these new variables.

### Case Study and Experimental Results:

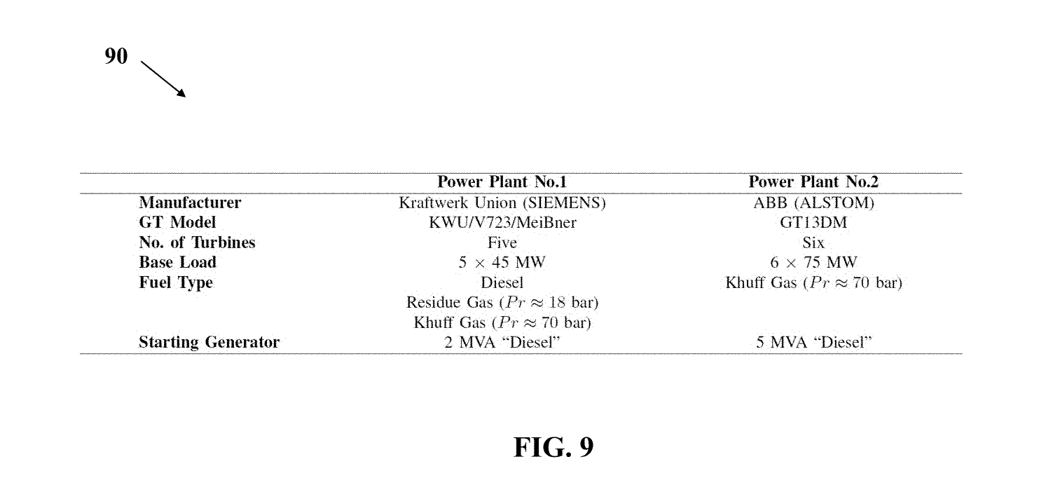

To evaluate the performance of this invention, it is important to use real data. For this mission, a real power system's operation logbook is taken as a case study. This power system contains two simple cycle power plants that were commissioned in the seventies and eighties of the last century. As described in 90 of FIG. 9, the first plant contains 5 gas turbines (GTs) with a base load of 45 MW of each unit, and they can be operated by either diesel or low/high pressure natural gases. The second plant contains 6 gas turbines with a base load of 75 MW of each unit, and they can only be operated by a high pressure natural gas. Thus, two sources of natural gas are used for these two power plants. The diesel, which is highly expensive, is used as an emergency fuel to supply the first power plant. Also, for a black-start condition, 2 MVA and 5 MVA diesel generators are used for the first and second power plants, respectively.

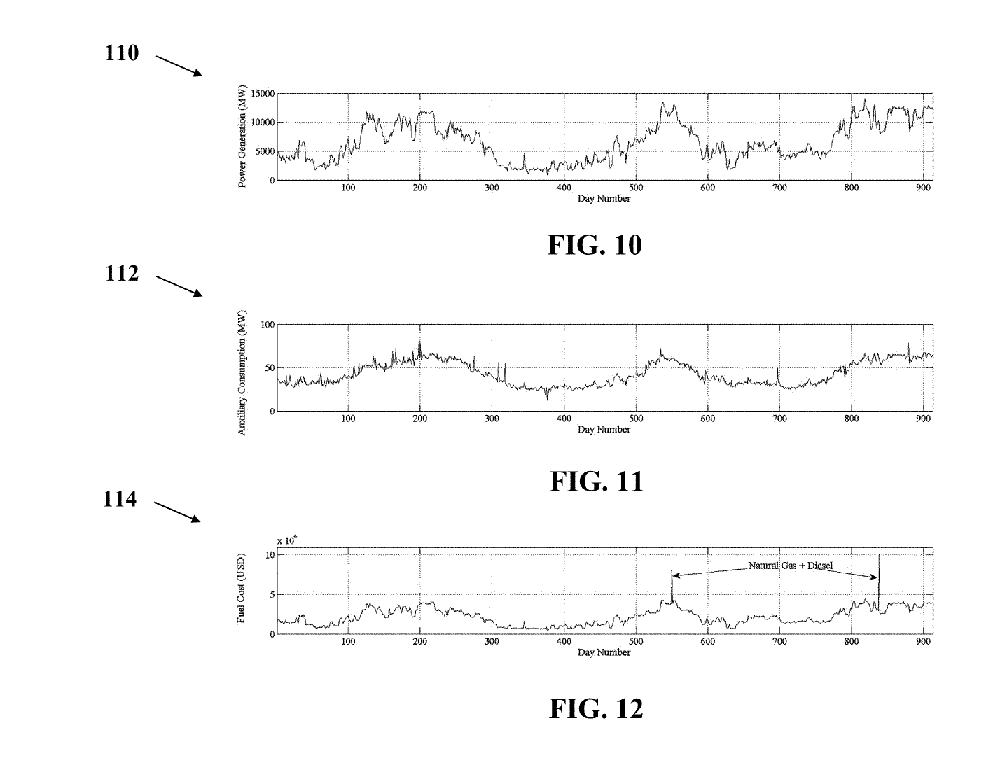

The data collected from the operation logbook of both power plants covers the power production from the 1 Jan. 2012 till the 31 Aug. 2014. The daily total power generation and auxiliary consumption for that period are graphically presented in 110 of FIG. 10 and 112 of FIG. 11, respectively; while the daily total price is shown in 114 of FIG. 12. From the last figure, it can be clearly seen that there are two very high readings. These two spikes happened due to consuming large amount of diesel, which is too costly, as a fuel. A simple daily operation record is shown in 160 of FIG. 21 for the day of 30 Aug. 2014, while 170 of FIG. 22 shows a one minute (specifically @ 11:32 AM) precise measurement of GT8 on the DCS' human-machine interface (HMI).

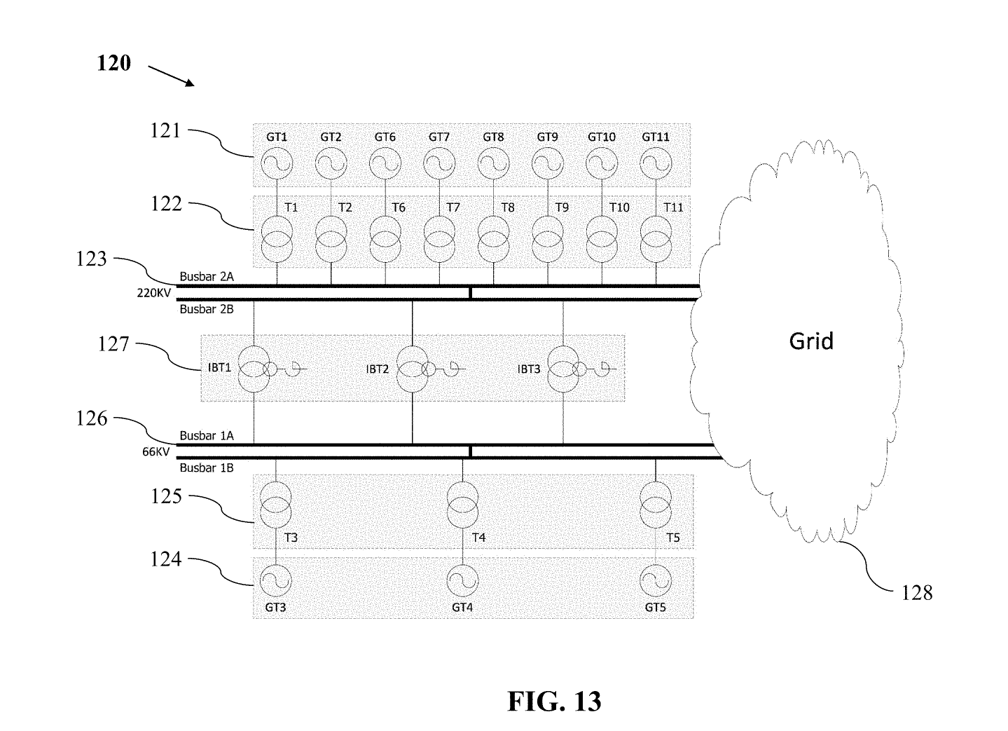

The electrical network of this power station (i.e., plants no. 1 and no. 2) is shown in 120 of FIG. 13. All the generating units 121 are stepped-up through power transformers 122 and then connected to redundant 220 KV transmission lines 123, except GT3-5 124, of the first power plant, which are stepped-up through power transformers 125 and then connected to 66 KV transmission line 126. These two standard voltage levels are connected to each other through three inter-bus transformers (IBTs) 127, and then connected to the national grid 128.

By referring to 20 of FIG. 2, 50 of FIG. 5, 70 of FIG. 7, and 81 of FIG. 8, suppose the global OMF-EELD converged to an optimal solution of a 11780MWd that the preceding power plant described in 90 of FIG. 9 and 120 of FIG. 13 (also, refer to 40 of FIG. 4, 60 of FIG. 6, and 85 of FIG. 8) should provide. Therefore, to meet that requirement in an optimal economic operation the xth local OMF-EELD (i.e., the one that belongs to 120 of FIG. 13) should be executed to search within the records stored in the operation logbook or the archiving server of the EMS software (refer to 10 of FIG. 1) in order to estimate the best possible solution. Here, the records of the operation logbook are considered; in order to prove that the huge records provided by archiving servers could lead to better results. Two scenarios are taken: finding the required real power without and with subtracting the auxiliary real power consumption (such these auxiliaries are: air compressors, water and oil cooling towers, local and main control rooms (LCRs and MCR), lightings, and air conditioning). The price of both natural gases was fixed at 2.25 USD for each 1 million British thermal unit (BTU).

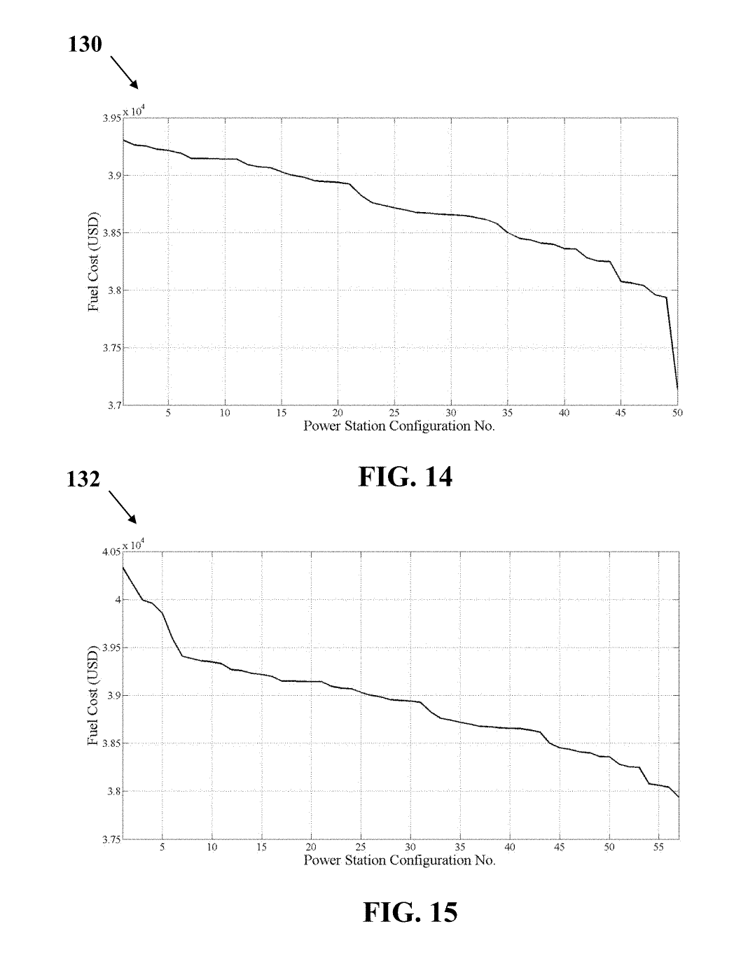

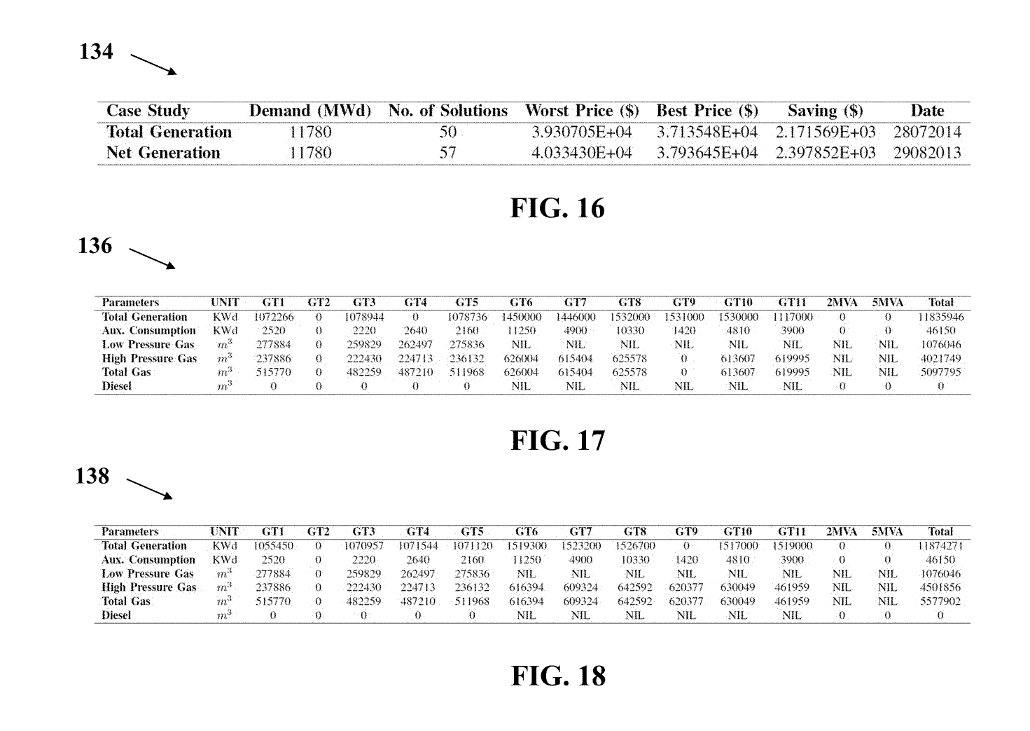

The final results of both scenarios are shown in 134 of FIG. 16. As can be seen from that table, the station can generate 11780 MWd with saving more than 2,000 USD, daily. That is, when the total generation is considered without subtracting the auxiliary consumption (i.e., the 1st scenario), then the estimated optimal configuration of the power station obtained from this local OMF-EELD happened in the 28 Jul. 2014; where all the possible configurations are plotted in 130 of FIG. 14, and the best one is shown in 136 of FIG. 17. Similarly, when the auxiliary consumption is subtracted from the total generation (i.e., to have the net generation, which is the 2nd scenario), then the estimated optimal configuration of the power station obtained from this local OMF-EELD happened in the 29 Aug. 2013; where all the possible configurations are plotted in 132 of FIG. 15, and the best one is shown in 138 of FIG. 18.

### Further Discussion:

From a practical view, many issues are not covered within the objective functions of the classical ELD problem formulation (i.e., without using our invention) that may affect the solution quality. Some of these considerations are:
Machines' efficiency degrades with the time after returning back from their minor/major overhauls.
Machines could be operated under high vibration, some partially or non-working burners, faulty thermocouples, errors on the opening of the fuel control valve, disturbances on air-mixing valve, etc, which have some effects on the efficiency and controller calculations.
The weather (including: ambient temperature, humidity, air quality, etc) could have significant effects on the machine's efficiency. It has been noticed that the efficiency markedly increases during winter and decreases during summer; for hot countries. This could be neglected if all the generating units are supposed to have similar linear efficiency curve, but in reality this assumption is not correct.

These practical aspects can affect, with some tolerances, the solution quality of the ELD problem when it is solved by the known classical techniques presented in the literature. These aspects are considered as part of uncertainty, which make a gap between the behavior of actual machines and their mathematical models. Thus, there is a drift between the optimal solutions (calculated using conventional- and meta-heuristic-based optimization algorithms) and the realistic optimal point that is supposed to be found. This invention can solve, or at least minimize, this gap by directly focusing on the actual measurements instead of translating the whole engineering problem into some optimization-based mathematical models. This gap can be effectively reduced if the size and type of the real data recorded in the operation logbook or/and archiving server(s).

Some advantages of using our invention:
It does not require constructing any objective function or its {a, b, c, d, e, f, α, β, γ, ξ, δ, etc} parameters.
It does not require satisfying any constraint, since all the candidate solutions are practical and feasible.
It does not require using any optimization algorithm, and hence it is a very fast technique.
It does not require using any mathematical model, so it can be carried out by any low-experienced operation manpower.
It can be done even with very old control system without any licensed ELD package in the EMS software. Actually, it can be done even within MS EXCEL and other free and open-source alternative software.
It is compatible with all types of power plants and technologies of generating units.
It does not require re-designing or re-programming the ELD solver if any new generating unit is added to the power plant.

The solution quality obtained by this invention could be enhanced if the planning department of each xth power station fulfills the following points:
The planned maintenance inspections and overhauls of the k generating units (refer to 30 of FIG. 3) are dispersed from each other to have a good diversity of station configurations, and hence covering the other parts of the practical search space where better configurations (i.e., estimated optimal solutions) could be detected.
The replacement, updating, and upgrading cost of plants' equipment and systems are well monitored; so the cash flow can be precisely monitored.
All the daily crew cost, annual leaves, allowances, bonuses, overtime, call-outs, etc, are well recorded; again, to enhance the actual monitoring of the preceding cash flow.

Add to that, linear and nonlinear interpolation methods could be involved here to predict new configurations that are located between some recorded configurations. Extrapolation could also be considered for finding new configurations located at the left or right of all the known real configurations. To explain how these interpolation methods work, suppose the following pure quadratic equation is proposed to explain the variability of the ith unit:

Cᵢ(Pᵢ)=200+10Pᵢ+0.0095Pᵢ²

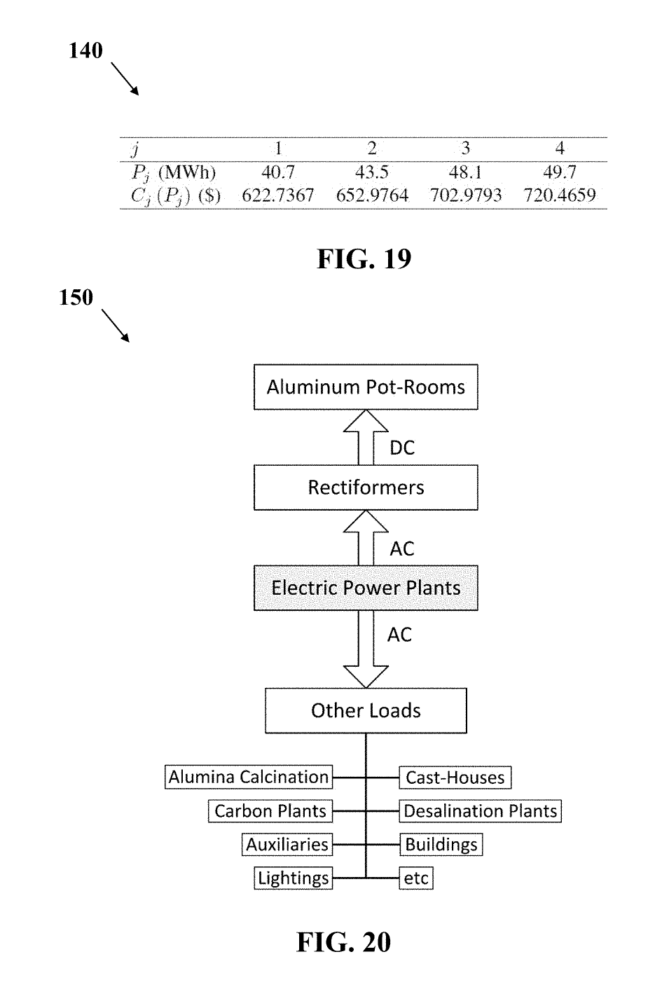

As said before, OMF-EELD technique do not require using any of these equations, but this mathematical model is shown here just to describe how the interpolation methods (i.e., not modeling the ELD problem) can be involved to enhance the overall performance of the proposed technique. Now, suppose the algorithm needs to estimate the fuel cost Cᵢ(Pᵢ) of a non-recorded set-point at P_{i,0}=46.3 MWh, and four pre-defined points of (Pᵢⱼ, Cᵢⱼ) that are given in 140 of FIG. 19. The following two interpolation methods are covered just to give a general idea about how to effectively enhance the accuracy of this invention:

### Classical Linear Interpolation:

This is the most simplest interpolation method, which works based on a linearized line between the nearest left and right points around the point (P_{i,0}=46.3, C_{i,0}=?). Based on the values given in FIG. 19:

$$\frac{{P}_{i , 3} - {P}_{i , 0}}{{P}_{i , 3} - {P}_{i , 2}} = \frac{{C}_{i , 3} - {\tilde{C}}_{i , 0}}{{C}_{i , 3} - {C}_{i , 2}}$$

$${\tilde{C}}_{i , 0} = {C}_{i , 3} - \frac{( {C}_{i , 3} - {C}_{i , 2} ) ( {P}_{i , 3} - {P}_{i , 0} )}{{P}_{i , 3} - {P}_{i2}} = 683.4129 \$$$

### Lagrange Interpolating Polynomial:

From the literature, it is known that the fuel-cost curve of real generating units can be fitted as a 2nd order (i.e., quadratic) or 3rd order (i.e., cubic) polynomial regression model; as seen before the “background of the invention” section. Thus, it is logical to shift from the previous simple linear interpolation process to a more suitable process called “Polynomial Interpolation”′. To estimate the unknown fuel cost of the preceding point (P_{i,0}=46.3, C_{i,0}=?), the Lagrangian-based polynomial interpolation approach can be applied using the known points of FIG. 19 as follows:

$${\tilde{C}}_{i , 0} = {\sum }_{j = 1}^{n} [ {C}_{i , j} {\prod }_{z = 1 \\ z \neq j}^{n} ( \frac{{P}_{i , 0} - {P}_{i , z}}{{P}_{i , j} - {P}_{i , z}} ) ] = 683.3651 \$$$

where n is the number of points used in the interpolation process, which is equal to 4 points as given in FIG. 19.

If that point (P_{i,0}=46.3, C_{i,0}=?) is analytically solved using the preceding quadratic equation, then:

C_{i,0}(P_{i,0})=200+10(46.3)+0.0095(46.3)²=683.3651$

Using this analytical value means the absolute error of the classical linear and Lagrangian-based polynomial interpolations can be calculated as follows:

AbsErr=|C_{i,0}−\tilde{C}_{i,0}|=|683.3651−\tilde{C}_{i,0}|
For classical linear interpolation: AbsErr=0.0479 $
For Lagrangian-based polynomial interpolation: AbsErr=1.1369E⁻¹³ $

Of course, the real readings of the ith unit do not necessarily follow the quadratic or cubic curve, but the preceding concept can be applied between very narrow real points to estimate new non-recorded real configurations. This may effectively improve the overall performance of the OMF-EELD algorithm and make it more flexible and practical to satisfy any power demand even those not recorded in operation logbooks or SCADA/DCS/RTUs/EMS servers.

### Aluminum Smelters' Power Plants—A Special Case of OMF-EELD:

Based on our background experience, OMF-EELD can be very competitive technique comparing to all other ELD solvers presented in the literature if it is used to solve the ELD problem of aluminum smelters' power stations. These power stations are considered as a special case where only semi-fixed load (multiple arrays of pots) is connected to a very short HVDC line (with subtracting the power consumption of auxiliaries and other loads) as shown in 150 of FIG. 20.

If this invention is applied here, then a high accurate solution could be obtained. This is because the total output of these power plants is almost constant where the electrodes of aluminum pot rooms are energized with a rectified electricity supplied from an array of special transformers called rectifier-transformers (or just rectiformers) for producing the aluminum through the electrolytic process. Based on that, all the recorded real configurations of these power plants are located near each other. Thus, if these configurations are translated as hypothetical solutions, then all these candidate solutions will cover large percentage of the practical and feasible search space of the ELD problem, because the aluminum production rate is almost stable with different configurations of the generating units. Therefore, the associated error with the OMF-EELD technique could be effectively minimized.

This invention could be hybridized with any of classical or modern optimization algorithms to merge the strengths of both approaches into a new superior technique, where the OMF-EELD stage could act as a master or slave unit.

1. An optimization/modeling free estimated economic load dispatcher (OMF-EELD), comprising:
a database of real input measurements, a database of real output measurements, and a mapping unit; wherein said mapping unit searches in said database of real input measurements and said database of real output measurements to determine the best available configurations of power stations and their generating units that satisfy load demand and network losses with the lowest possible operating cost. This strategy does not need to use any mathematical model or optimization algorithm where all the solutions are practical and feasible. It can be used in all types of generating units and all types of power stations, especially those of aluminum smelters;
wherein said database of real input measurements can be created by utilizing the information recorded in operation logbooks, archiving servers, or both operation logbooks/archiving servers;
wherein said database of real output measurements can be created by utilizing the information recorded in operation logbooks, archiving servers, or both operation logbooks/archiving servers.
The data length of said operation logbooks could be recorded per hour, day, or at each manpower shift.
The data length of said archiving servers could be recorded per day, hour, minute, second, or millisecond.
The data utilized from said archiving servers could come from SCADA, DCS, RTUs, or/and EMS.
The structure of said OMF-EELD can be in a one common block if it is used in a monopoly market, where the cost of both the units power settings and network losses can be minimized.
The structure of said OMF-EELD can be split into one global OMF-EELD and multiple local OMF-EELDs.
The main purpose of said global OMF-EELD is to minimize the network losses by estimating the best configurations of power stations committed to the grid.
The main purpose of said multiple local OMF-EELDs is to minimize the fuel cost of power stations by estimating the best power settings of generating units.

2. The searching process of said mapping unit can be enhanced by employing extrapolation and/or interpolation;
wherein said extrapolation could be in a linear or nonlinear form;
wherein said interpolation could be in a linear or nonlinear form.

3. The whole process of claim 1 and claim 2 could be further enhanced by hybridizing said OMF-EELD with a classical or modern optimization algorithm;
wherein said OMF-EELD could act as a master unit by letting it to guess the initial best configuration of power plants and their generating units before being fine-tuned by said classical or modern optimization algorithm; or
the unit of said OMF-EELD could be employed as a slave unit where the initial best configurations of power plants and their generating units are proposed by said classical or modern optimization algorithm and then said OMF-EELD starts searching for the best configurations from said database of real input measurements and said database of real output measurements, and also from said extrapolation and said interpolation.
